(19) United States
(12) Patent Application Publication
(10) Pub. No.: US 2007/0004399 A1
(43) Pub. Date: Jan. 4, 2007

(54) Quality assessment for telecommunications network

(75) Inventors: Jaana Laiho, Veikkola (FI); Mikko Kylvaja, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/434,924

(22) Filed: May 17, 2006

(30) Foreign Application Priority Data
Jun. 29, 2005 (GB) GB 0513294.9

(51) Int. Cl. H04Q 7/20

(52) U.S. Cl. 455/423

(57) ABSTRACT

A method and apparatus of assessing quality in a communications network are provided including selecting at least one information source for at least one service or user group, collecting data from said at least one information source, and processing the collected data in a neural network.

### BACKGROUND OF THE INVENTION

1. Field of the Invention

The present invention relates to the derivation of quality information in a telecommunications network, and particularly but not exclusively in a telecommunications network having multiple domains, and multiple virtual operators. The multiple domains may include, for example, access technologies, radio core network, circuit switched core network, packet switched core network etc.

2. Description of the Related Art

Telecommunication systems, and more particularly mobile telecommunication systems, are widely known. A typical mobile telecommunication system comprises a plurality of users each having a mobile station or user equipment, for connection via a radio access network to a core telecommunications network. The users may access applications and services in application/service networks via the telecommunications core network. A typical mobile communications network is made up of many network elements, and many network interfaces. Multiple applications and multiple services are typically provided for mobile users.

In addition, in a typical practical mobile telecommunications network implementation cellular operators may lease airtime from infrastructure owners, thereby being “virtual operators”. The requirements of such virtual operators typically change the needs and requirements of network and service management systems. The change from monitoring voice traffic only in early mobile telecommunication networks to monitoring multiple virtual operators each carrying multiple applications is significant. The monitoring task cannot be handled by current systems.

In the near future, mobile telecommunication systems will require service assurance (SA) and service level agreement (SLA) management tools. In order to provide such management tools, it is preferable to provide a technique for assessing the quality of service provided in the mobile telecommunication system.

In the prior art, there is no satisfactory technique for assessing quality of service taking into account multiple applications and services provided by multiple virtual operators, and further taking into account that the data through which an application or service is provided to a mobile station is transported through multiple domains, such as the radio network and the core network.

### SUMMARY OF THE INVENTION

It is an aim of the invention to provide an improved technique for assessing the quality of services and/or applications provided in a mobile telecommunications network.

According to one aspect of the invention there is provided a method of assessing quality in a communications network, the method comprising: selecting at least one information source for at least one service or user group; collecting data from said at least one information source; processing the collected data in a neural network.

The information source may be a system user. The system user may be a mobile terminal user. The data may be collected from the mobile terminal.

A plurality of information sources may be selected, the method further comprising the step of correlating data retrieved from said plurality of information sources.

The step of correlating the data may further include a step of augmenting the data.

The data retrieved from said at least one information source may be passive data.

Said at least one information source may comprise a network element, a group of network elements, a network interface, or a group of interfaces.

The method may further comprise defining a level of application service for each service in dependence on the data retrieved from the at least one information source.

The quality level of application service for each service may be defined for a plurality of cells.

The cells may be grouped into clusters according to levels of application service.

The method may further comprise the step of accumulating data in dependence on active measurements.

The active measurements may be field measurements. The active measurements may be mobile trace measurements. The active measurements may be end to end measurements for a given connection.

The method may further include the step of collecting subjective data from at least one information source. The method may further include the step of collecting network element parameters which are responsive to the network element performance. The method may further including the step of collecting element parameters which has been entered into the network element. The parameters may have been entered by the user of the element.

The network element may be a mobile terminal.

The at least one information source for subjective data may be a mobile terminal.

The user-entered parameters may form a subjective index to the measurement data for a given cell. The user entered parameters may provide an indication of a statistical quality of end user experience. Data collected from an information source may be a data subset.

The method may further comprise the step of selecting at least one information source for a plurality of services or applications. The plurality of services may include one or more of WAP services, multimedia services or streaming video services.

The method may further comprise selecting at least one information source for at least one service for a plurality of virtual operators. The collected data may be performance data.

In a further aspect of the invention there is provided a terminal having a user interface for receiving user inputs, and a communications interface for connection to a communications network, wherein the user interface is configured to receive user parameters, and the communications interface is configured to transmit such parameters to the communications network.

The user parameters may be indicative of a user's experience of using the communications network. The user parameters may be entered by selecting a numeric option. The numeric option may be provided by selection of a corresponding numeric keypad on the terminal. The communications interface may be configured to transmit such parameters using a messaging service. The terminal may be a mobile terminal.

In accordance with a further aspect of the invention there is provided a network element in a communications system, having a communications interface for receiving data from a terminal connected in said communications system, said data being representative of a user experience, and being configured to provide said data to a learning neural network.

The neural network may learn the parameters associated with unacceptable system level performance. The neural network may generate an alarm signal responsive to receipt od data associated with poor system level performance.

In accordance with a further aspect of the invention there is provided a computer program for a mobile terminal for connection in a communications network, the computer program controlling the mobile terminal by: displaying on a graphical user interface a selection of user experience quality of services; receiving a user input from the terminal user interface; and storing the user input into the terminal memory

The computer program may further comprise after receiving a user input from the terminal user interface, reading the performance related parameters from the registers of the mobile terminal, and storing the parameters into the memory together with the user input. The computer program may further comprise starting automatically during a connection to the mobile network.

### BRIEF DESCRIPTION OF THE FIGURES

The invention, and embodiments thereof, will now be described by way of example with reference to the accompanying drawings in which:

FIG. 1 illustrates an exemplary mobile telecommunication system adapted in accordance with the principles of embodiments of the invention;

FIG. 2 illustrates a flow process in an exemplary embodiment of the invention;

FIGS. 3a and 3b illustrate the retrieval and processing of data from the mobile telecommunications network of FIG. 1 in an embodiment of the invention;

FIGS. 4a and 4b illustrate performance maps in accordance with an embodiment of the invention;

FIGS. 5a and 5b illustrate a “performance map” in accordance with a further embodiment of the invention; and

FIG. 6 illustrates a performance map in accordance with a still further embodiment of the invention.

### DESCRIPTION OF THE PREFERRED EMBODIMENTS

The invention is described herein by way of reference to a particular exemplary implementation, and specifically by way of reference to quality assessment in a third generation (3G) mobile telecommunication system. It should be understood that the principles of the invention extend beyond the specific exemplary implementation provided herein, and is more generally applicable to mobile telecommunication systems other than those presented herein.

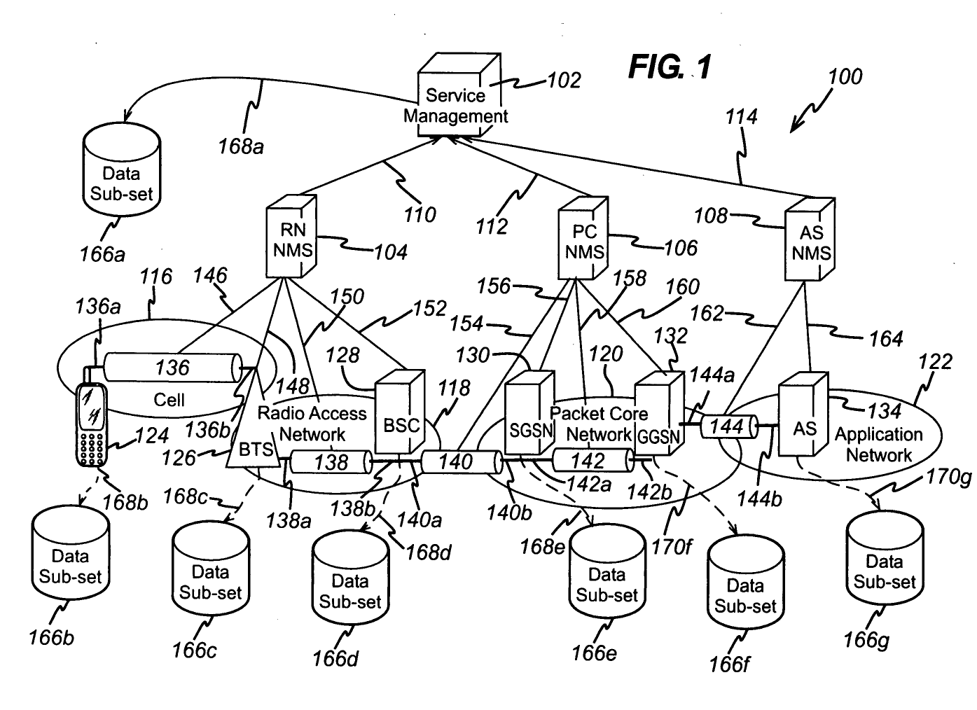

Referring to FIG. 1, there is illustrated an exemplary third generation mobile telecommunication system. A mobile station or user equipment 124 is associated with a user of applications and/or services, access to which are provided by a telecommunications network. The user, at any instance in time, is located in a particular cell of the telecommunications network. In FIG. 1, the user is currently located in a cell 116. The radio access area of the cell 116 is defined by the radio transmissions of a base transceiver station (BTS) 126. The base transceiver station 126 is associated with a base station controller (BSC) 128. The base transceiver station 126 and the base station controller 128 together form part of a radio access network 118. In practice, the radio access network 118 provides a plurality of base station controllers, each associated with one of a plurality of base transceiver stations. The radio access network 118 provides access to a packet core (PC) network 120 for users of the mobile telecommunication system, such as a user associated with the mobile station 124. The packet core 120 is shown in FIG. 1 to comprise a serving GPRS support node (SGSN) 130 and a gateway GPRS support node (GGSN) 132. In practice the SGSN 130 and the GGSN 132 support a particular telecommunication session. The packet core network 120 may include further SGSNs and GGSNs, as well as further network elements. The packet core network 120 is further adapted to provide access to application networks, such as application network 122. In FIG. 1, the application network 122 includes an application server (AS) 134 for providing applications and/or services to mobile users.

It will be understood that in FIG. 1 only the basic elements of a mobile telecommunication network, generally designated by reference numeral 100, are illustrated for ease of description. The full implementation of a mobile telecommunications network will be understood by one skilled in the art. Only sufficient network elements are shown in FIG. 1 as to provide an understanding of the invention and embodiments thereof.

Referring again to FIG. 1, it can be seen that the mobile telecommunications system is further provided with network management systems. A radio network (RN) network management system (NMS) 104 is provided to manage the radio access network and access to the mobile user. A packet core (PC) network management system (NMS) 106 is provided to manage the packet core 120. An application server (AS) network management system (NMS) 108 is provided to manage the application network 122. In addition for circuit switched traffic appropriate core elements can be included, as will be understood by one skilled in the art. These are not illustrated in the Figure, to keep the figure simple and easier to understand.

The interconnection of each of the network elements of the mobile telecommunications network is now further discussed. As can be seen, a communication channel 136 is established between the mobile station 124 and the base transceiver station 126. A communication channel 138 is established between the base transceiver station 126 and the base station controller 128. A communication channel 140 is established between the base station controller 128 and the SGSN 130. A communication channel 142 is established between the SGSN 130 and the GGSN 132. A communication channel 144 is established between the GGSN 132 and the application server 134. As can be further seen in FIG. 1, each communication channel is provided with an interface at ends thereof which interface with the respective network element. For example, an interface 136a is provided for the communication channel 136 to interface with the mobile station 124, and an interface 136b is provided for the communication channel 136 to interface with the base transceiver station 126. Similarly, each of the communication channels 138, 140, 142 and 144 is provided with interfaces denoted a and b at respective ends thereof, for interfacing the respective communication terminal with the network elements between which a connection is formed thereby.

As described hereinabove, the mobile communications network 100 of FIG. 1 can be considered to comprise of three domains, being the routing network domain, the packet core domain, and the application server domain. Thus, it will be understood that each of the network management systems 104, 106 and 108 is a network management system for a respective domain. As illustrated in FIG. 1, each of the network management systems is provided with connections to various network elements, communication channels, and interfaces within the respective domain. The radio network management system 104 is provided with a connection 146 to the communication channel 136, a connection 148 to the base transceiver station 126, a connection 150 to the communication channel 138, and a connection 152 to the base station controller 128. The packet core network management system 106 is provided with a connection 154 to the communication channel 140, a connection 156 to the SGSN 130, a connection 158 to the communication channel 142, and a connection 160 to the GGSN 132. The application server network management system 108 is provided with a connection 162 to the communication channel 144, and a connection 164 to the application server 134. Each of the network management systems 104, 106, 108 is provided with a further respective communication 110, 112, 114 respectively to a service management block 102. The service management block 102 is the overall service management for a given service within the mobile telecommunications network.

In accordance with an embodiment of the invention, a plurality of data storage means, denoted 166a to 166g, are provided to monitor activity of the mobile telecommunication system (or other communications network) at various points thereof. A data storage means 166a retrieves data from the service management block 102 via communication link 168a, a data storage means 166b retrieves data from the mobile terminal 124 via communications link 168b, a data storage means 166c retrieves data from the base transceiver station 126 via communication link 168c, the data storage means 166d receives data from the base station controller 128 via communication link 168d, the data storage means 166c receives data from the SGSN 130 via communication link 168e, the data storage means 166f receives data from the GGSN 132 via communications link 170f, and the data storage means 166g receives data from the application server 134 via communications link 170g.

Thus it can be seen that in this embodiment of the invention each of the individual network elements is provided with a respective data storage means for retrieving and storing data associated therewith, and in addition the service management block 102, which is the overall management block for the system, is provided with a data storage means for retrieving and storing data associated therewith. Each of the data storage means is considered to retrieve and store a data sub-set.

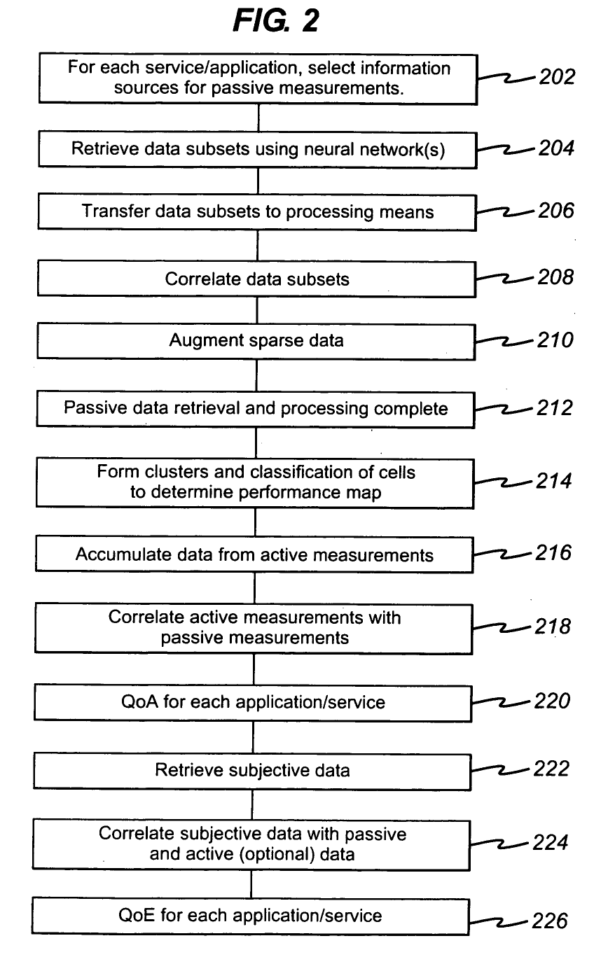

The principles of the invention, as applied to a particular embodiment, will now be further described with reference to the flow process of FIG. 2.

In a first step 202, for each service/application, at least one information source is selected, and preferably a plurality of information sources are selected. In FIG. 1, the information sources selected are each of the network elements 124, 126, 128, 130, 132, 134 and 102. It should be noted that additional information sources may be selected. Furthermore, a selection of information sources is not restricted to the selection of network elements. The information sources may be a particular communication channel or a particular interface or network element(s). It should also be noted that in selecting the information sources, it may first be decided as to which domains the information sources should be selected from. In the example of FIG. 1, information sources are selected from all available domains. In alternative implementations, the information sources may be selected from some but not all domains.

In accordance with preferred embodiments of the invention, the collection of data, to form data sub-sets, for each selected information source is carried out as an automatic, intelligent process, which is unsupervised.

Typically a NES produces thousands of measurement “items”, or counters. The NES measures parameters at various points throughout the network. A data subset is a pre-filtered set of those measured items. A filter can be, for example, a time window or a certain functionality, such as packet scheduler functionality.

In a preferred embodiment of the invention, the monitoring of the information sources in order to provide the data sub-sets is achieved using one or more neural networks, as denoted by step 204.

After retrieval of the data sub-sets in step 204, the data sub-sets are forwarded to a processing means for further processing as denoted by step 206. In a step 208 the data sub-sets retrieved are then correlated. The purpose of the correlation is to reduce the amount of information, align the measurements time-wise etc. During cancellation, data of different nature can be combined by cancellation.

Thereafter, in a step 210, any sparse data is augmented. The step of augmenting sparse data is likely to be particularly advantageous where there are periods of time where no data is retrieved, due for example to network inactivity at the particular information source for a particular service. Furthermore, if the information sources are selected such that not all network elements are measured, then the retrieved data sub-sets may need to be augmented to allow for the network elements which have not been monitored. As the data available from the network is not perfect due to these reasons, augmentation of the data may be advantageous.

In combination, the correlation and augmentation steps 208 and 210 enable the retrieved data sub-set to be collated and enhanced. The correlation may particularly be used where it is necessary to take into account different time granularity between the data retrieved from different information sources.

In combination information from different sources are combined, and a full picture is formed. The nature of the data can be different. For example one set may be at a cell level, and another set may be at a connection level. In another example one set may be active and another set may be passive. A first and second set of source data may have some intelligence applied thereto in order to generate a combined data set.

If there is data missing, for example either because a particular network element has not been monitored or because there was no activity in the timeframe monitored, the data is augmented to compensate for this. The data augmentation is based on neural network analysis. If there is a missing value or values in a data sample, a neural network can be used to provide a good estimate that is based on neurons having similar behaviour.

In a simple example, a sample vector size may be of 10 values. A neural network is taught with these kind of samples and in the end the neural network is a “model” of the network behaviour. A sample is then obtained that has only 8 values, i.e. 2 values are missing. The neural network can be used to estimate the missing two samples based on the knowledge it contains.

In another example, all the network indicators of all the elements are measured and stored in an OSS database. Additionally, a smaller area can be expected where more detaled drive tests about quality of service (QoS) can be performed. This detailed QoS drive test can be used to predict the QoS also in parts of the network where detailed data is not collected. This is one of the benefits of using a neural network.

The augmentation and correlation steps may be distinct steps, or may be combined in a single step. The correlation and augmentation steps are preferable steps. However if the operator has all the desired data, but in practice there are larger/smaller gaps in the data, augmentation is needed.

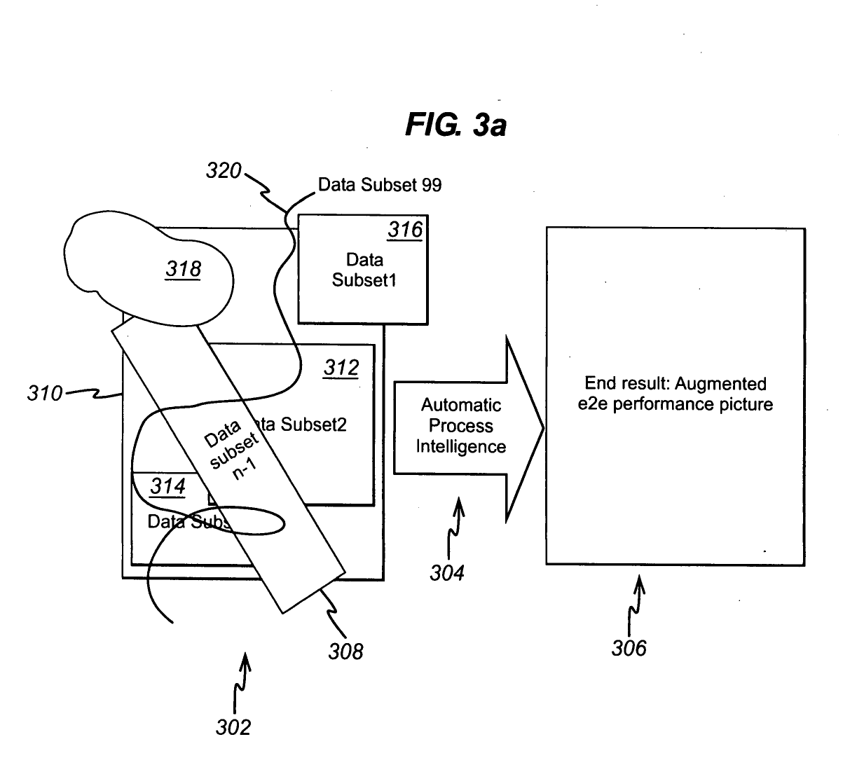

The correlation and augmentation steps 208 and 210 are further illustrated with references to FIGS. 3a and 3b. FIG. 3a illustrates schematically the principle of retrieving data sub-sets and processing them. As generally denoted by reference numeral 302, in general there may be considered to be n data sub-sets retrieved from the communication network for each application/service. In general, the data of certain sub-sets may overlap. As denoted in FIG. 3a, a first data sub-set 316 is illustrated, as is a second data sub-set 312, a third data sub-set 314, a fourth data sub-set 318, a fifth data sub-set 310 a 99^{th} data sub-set 320, and a n-1 data sub-set 308. As can be seen, the data sub-sets in FIG. 3a are illustrated schematically, such that certain data sub-sets overlap each other. Thus, this illustrates that the content of certain data sub-sets overlaps.

The data sub-sets 316, 312, 314, 318, 310, 308 represent passive measurements collected from the network management system, such as represented by the data sub-sets 166 of FIG. 1. The data sub-set 99, denoted by reference numeral 320, represents an active measurement. Active measurements will be discussed further hereinbelow, but in general are provided by a probe providing end-to-end quality analysis of a single connection. As can be seen from FIG. 3a, the end-to-end connection represented by data sub-set 302 traverses various other data sub-sets, which collect sub-sets for all connections, or a group of connections, at a particular network element.

As denoted by block arrow 304 in FIG. 3a, the various data sub-sets are taken as inputs to an automatic process intelligence block, preferably a neural network, which results in a block 306 providing an augmented end-to-end performance picture, for each individual session established to a particular service/application.

The principles of FIG. 3 are illustrated further in FIG. 3b. Each data sub-set 1, 2, n, denoted by reference numerals 320a to 320n, is provided to one or more neural networks 322, which in turn provide the results 324.

Referring again to FIG. 2, after correlation and augmentation of the data, the retrieval and processing of passive data is complete, as denoted by step 212. Passive data is considered to be data retrieved from the network management system, or directly from network elements. The neural networks used in the retrieval of the passive data may be further trained using the passive measurements obtained from the network management system and other relevant tools.

In a step 214, the information established using the passive data retrieval and processing may be used to classify the cells of a cellular network in terms of service performance. A service performance map may then be prepared, which is fully technical based on retrieved passive data. Thus a clustering may be formed.

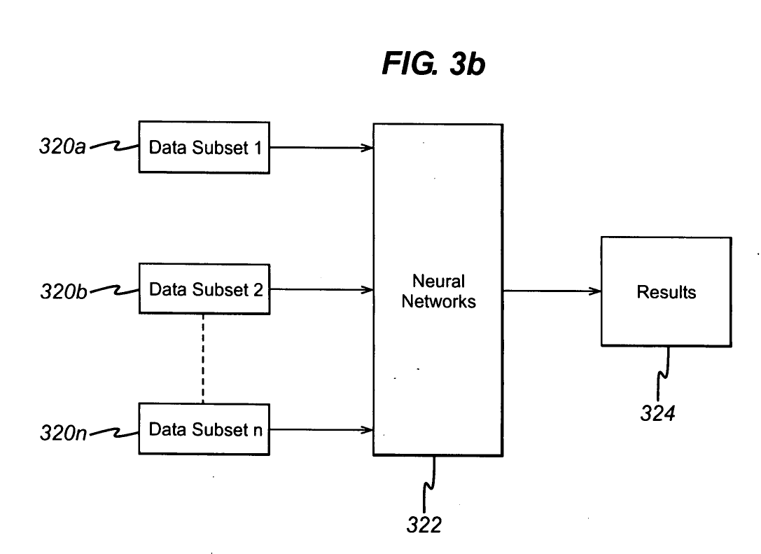

A performance map established at step 214 is illustrated in FIG. 4a. Referring to FIG. 4a, there is shown a section of a cellular mobile telecommunications network, illustrating a plurality of cells in such section. As can be seen in FIG. 4a, the cells have been grouped into different groupings, represented by different shadings, corresponding to different levels of service. Thus in the clustering step, based on the available levels of service determined in the processing steps, bands of levels of service are determined, and cells allocated to such bands. Thus, referring to FIG. 4a, the various different shadings relate to different cells which have been clustered together, in terms of their performance.

In a next step, denoted 216, active measurement results are preferably collected. The active measurement results may fall into one of two categories. In a first category, probes may be provided to provide end-to-end quality analysis information in respect of a single connection. In a second category, field measurements may be taken into account to provide measurement results. Field measurements may, for example, comprise a car driving along a predetermined route, and collecting data. Mobile trace information is a term understood by one skilled in the art.

At this step, an advantage can be gained by having already accumulated and processed the passive measurements. As part of the processing of the passive measurements in step 214, it can be identified which passive measurements are considered to be good enough indicators to partly compensate for the lack of active measurements. This may reduce the number of active measurements which are needed. All active measurements are collated and then correlated with the passive measurements. However, it is not essential for the passive measurements to have been taken/processed before the active measurements take place.

In a step 218, the results of the active measurements are then correlated with the processed passive measurements. Referring to FIG. 4b it can be seen that a number of cells are denoted as having square boxes, representing cells in respect of which passive measurements are available associated with an end-to-end connection. The point is that only active measurement samples are needed with this method. Active measurements may be obtained for the cells, using either probes or a field tool, and then correlated with the existing passive measurements.

Thus a cluster characterising a service in a cell, is capable of providing end-to-end performance indication of the service in question.

Referring to FIGS. 4(a) and 4(b), if only passive measurements are available for those cells which have square boxes in, albeit it is still possible to cluster all of the cells without square boxes with the cells with square boxes. However without active measurements, the information is not as good and it is not possible to predict much about the end user quality.

Thus, mobile trace functionality may be used to provide a more focused picture on the application performance. These active measurements are not mandatory in the training of the neural network. Rather active measurements are used for labelling each of the clusters formed by a self-organising map, which is formed by the neural network acting on the passive measurements, or any other unsupervised analysis method.

After completion of step 218, in a step 220 a quality of application (QoA) result is available for each application/service, as denoted by step 220.

It is important to synchronise the passive measurements obtained from the network elements on the network management system, and the active measurements obtained, for example, from a end-to-end trace. That is, it is important to have the performance statistics from the network at the same time as the trace data is collected.

After the initial establishment of the monitoring system, and after the neural network has been taught, any situation in the network may be characterised with an application specific grading. This grading may be, for example, bronze, silver, gold level. The statistics collected from a particular cell may indicate that the performance for a particular application is not idealised, and only at a level which would be acceptable to a silver user (or bronze user) and not to a gold user. Or to a service which requires gold level quality.

The granularity (i.e. amount of) of the clusters may vary. In the example above, where reference is made to bronze, silver, gold, three granularities are provided. Larger degrees of granularity may be provided.

Thus any value combination of technical performance measurements can be easily converted to a quality of application grade. The actual measurements need to be the same as in the teaching phase. The actual measurements in the teaching phase are thus from the real network.

The measurements collected for the teaching of the neural network are preferably from a cell or a cell cluster, for example from a city centre. The cells in the cluster should preferably have the same performance target. Each application is provided with its own quality of application map.

FIG. 4b further illustrates the augmentation of data. FIG. 4b shows the trained neural network. In FIG. 4b there are samples located to NN. The sample values can be located to NN even if they are not complete samples (i.e. if some samples are missing). The missing values can be taken from the neuron where the sample is located.

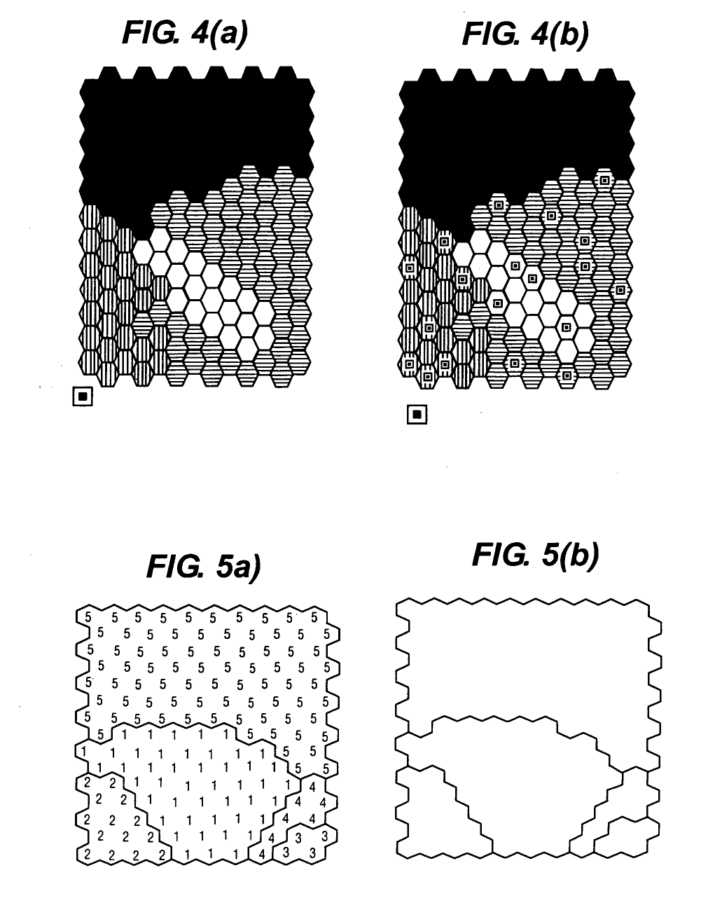

Referring to FIGS. 5a and 5b, there is provided an illustration of a possible implementation.

Referring to FIG. 5a, there is again shown a section of a cellular structure of a cellular mobile communications network. The cells are grouped into five separate clusters, each cell having a numeral 1, 2, 3, 4 or 5 denoting association with a particular cluster. For the purposes of example, it is assumed that numeral 1 relates to the application service being good enough for a gold user, numeral 2 relates to the application service being acceptable for a gold user, number 3 relates to the application service being good enough for a silver user but not acceptable for a gold user, number 4 indicates an application service acceptable for a silver user, and number 5 indicates an application service acceptable only for a bronze user.

Once the quality of application information is completed at step 220, a quality experience of end user map (QoE) can be prepared. In the case of QoE, the subjective (i.e. human) view of the quality of the call is an important piece of information, and this information may be added to the training of the neural network.

All available measurement and quality data should preferably be used when training neural networks.

In establishing the QoE map, it is necessary that the passive measurements, i.e. the network measurements, are provided to characterise the technical behaviour of the sub-area of the network, for example a cell. The active measurements are optional. The minimum requirement for establishing the QoE map is that the subjective user measurements are combined with the passive measurements from the network. These are used in combination by the neural network to “stamp” each technical cluster with subjective information.

One way of adding a QoE stamp (or signature) is to record a human opinion at the same time as the probe or other active measurement is performed. In such a case, each square in FIG. 4b additionally represents a subjective opinion of the service performance. In such a case active means is mandatory.

As in correlating the active and passive measurements described hereinabove, the neural networks may synchronise the subjective measurements with any other measurements used. Referring once again to FIG. 2, step 222 illustrates the retrieval of subjective data. As represented by step 224, the retrieved subjective data is then correlated with the passive data retrieved in the earlier steps, and optionally with the retrieved active data.

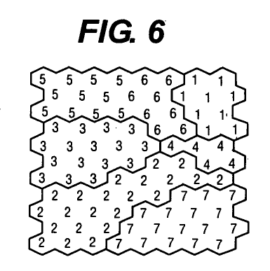

Referring to FIG. 6, this illustrates a visionary QoE map for a video conferencing example. Again, each cell of the map is denoted by a number, and the cells grouped into clusters associated with the numbers. Number 1 indicates that the service in the particular cell performs better than expected by the user, number 2 indicates that the user is satisfied, number 3 indicates that the user can accept the performance, number 4 indicates that the user considers the service tolerable, number 5 indicates that the user is becoming frustrated, and number 6 and 7 indicate that the user is unsatisfied.

The QoE map of FIG. 6 includes the passive or active data. One of such data is mandatory and in some cases both may be mandatory. As suggested by FIG. 2, the QoE is achieved by following directly on from the QoA results. Only the subjective valuation is added.

As a result, there is provided a discrete, highly abstracted, statistically valid end user satisfaction indication. This is achieved by combining the subjective information provided by an end user, with the passive data and optionally active data results accumulated through the network. This is represented schematically in FIG. 7.

As discussed hereinabove, the initial basis for establishing the passive measurements upon which the quality assessment is based is to collect performance data from network elements. This can be obtained directly from individual network elements, or from the network management system associated with individual network elements. For example, it may be particularly advantageous to collect the measurements directly from the network elements rather than the network management system if the time resolution of the measurements required is higher than can be obtained through network management system interaction.

Active measurements give detailed information on a session call. In order to obtain an active measurement, one probe per session is required. This is an expensive solution where hundreds or even thousands of sessions may be established in a system. Thus, the use of the passive measurement to reduce the amount of active measurements required is desirable. This is achieved with data correlation.

In order to obtain the QoE analysis, survey measurements are necessary. So-called friendly users may be used to determine the network performance from the end user point of view. These users may have a predefined set of applications that they are required to use daily, and report on the performance in a subjective way. They may also report on the performance in an objective way, such as commenting on delays and blocking for example.

A further source of active measurements is field measurements, for example drive tests carried out by the operator themselves, where a mobile station is driven along a predetermined route and the measurements accumulated.

In addition to the above-mentioned measurement methods, it is also possible to trace certain mobile stations or user equipment and acquire uplink and downlink performance data during the active time of the user. The mobiles to be traced in this way are preferably those used in the survey active measurements.

The combination of neural networks with either a quality of application or quality of end user in accordance with embodiments of the invention provides a new way of performance visualisation. Embodiments of the invention enable a subjective measure, being quality of end user, and an objective measure, being quality of application, to be provided to network operators. This information may then be used in network optimisation and operator business strategy planning.

The invention particularly provides a mechanism for detecting errors in the network which are not ‘normal’ errors. A ‘normal’ error may occur, for example, when the fault is not in the network. An example may be an overload of one or more base stations due to a sudden demand by mobile users. This may be, for example, due to a passenger ship passing a base station on an island at the same time very afternoon. The mechanism provided by this invention learns that something negative happens at a recurring frequency, but it is not something which justifies reconfiguration of the network.

The learning process according tot eh described mechanism is preferably achieved by using a neural network SOM. The application of an SOM in the context of the mechanism described herein is novel.

The described mechanism allows many parameters (potentially thousands) in the network to a user experience. A user experience is not possible to measure qualitatively, so the only way to achieve this is to allow users to provide input regarding their experience. The mechanism described herein allows for this ‘user experience’ to be further processed to hep the network operator. The SOM learns the characteristics of network parameters, and user inpout, so that without any final user input the SOM system knows what the user input might be. The system may now know, for example, that the user must be very unsatisfied, and may then alarm the operator. A suitable SOM for this purpose, which may be used in combination with the mechanisms of the invention described herein, is described in EP-A-1325588.

The mechanism for a user to provide information on their experiences is not a part of the invention. In a preferred embodiment it is likely that the user will use their mobile terminal. An SMS message may be sent.

When the network receives the indication from the terminal, it preferably instantaneously reads a set of network parameters, for example in the RNC. These parameters are then entered into the SOM for learning. This learning process may continue, or may occur once on the basis that once the SOM has learned the system behaviour once the system may not need to learn the system anymore.

Thus during the use of the system the RNC (for example) observes its parameters, enters them into the SOM, and by using the learned configuration the SOM is able to alarm the operator when the parameters have similar characteristics to the earlier situations when the user was unsatisfied. Thus an alarm may be generated.

This alarm may then be used for building statistics to help identify spots in the network that do not provide satisfactory service, or by instant checking by operators for checking if the system is working well when the alarm takes place.

Preferably the user input is provided by selected users, rather than all users, who may have special terminals configured for providing user input. The users may be trained to provide such information.

The invention has been described herein by way of reference to particular, non-limiting examples. In particular the invention has been described in the context of a third generation mobile telecommunication system. The invention is not limited to such application, and one skilled in the art will appreciate the techniques associated with the invention may be more broadly applied. The scope of the invention is defined by the appended claims.

1. A method of assessing quality in a communications network, the method comprising:
selecting at least one information source for at least one service or user group;
collecting data from said at least one information source; and
processing the collected data in a neural network.

2. A method according to claim 1, wherein the information source is a system user.

3. A method according to claim 2, wherein the system user is a mobile terminal user.

4. A method according to claim 3, further comprising:
collecting the data from the mobile terminal.

5. A method according to claim 1, further comprising:
selecting a plurality of information sources; and
correlating data retrieved from said plurality of information sources.

6. A method according to claim 5, wherein said correlating of the data further comprises augmenting the data.

7. A method according to claim 1, further comprising:
collecting the data from said at least one information source as passive data.

8. A method according to claim 1, wherein said at least one information source comprises a network element, a group of network elements, a network interface, or a group of interfaces.

9. A method according to claim 1, further comprising:
defining a level of application service for each service in dependence on the data collected from the at least one information source.

10. A method according to claim 9, further comprising:
defining a quality level of application service for each service for a plurality of cells.

11. A method according to claim 10, further comprising:
grouping the cells into clusters according to levels of application service.

12. A method according to claim 8, further comprising:
accumulating data in dependence on active measurements.

13. A method according to claim 12, wherein the active measurements are field measurements.

14. A method according to claim 12, wherein the active measurements are mobile trace measurements.

15. A method according to claim 12, wherein the active measurements are end to end measurements for a given connection.

16. A method according to claim 1, further comprising:
collecting subjective data from at least one information source.

17. A method according claim 1, further comprising:
collecting network element parameters which are responsive to the network element performance.

18. A method according to claim 1, further comprising:
collecting element parameters entered into the network element.

19. A method according to claim 18, further comprising:
entering the parameters by a user of the element.

20. A method according to claim 18, wherein the network element is a mobile terminal.

21. A method according to claim 17, wherein the at least one information source for subjective data is a mobile terminal.

22. A method according to claim 17, further comprising:
forming a subjective index to measurement data for a given cell using the user-entered parameters.

23. A method according to claim 22, further comprising:
providing an indication of a statistical quality of an end user experience using the user entered parameters.

24. A method according to claim 1, further comprising:
collecting the data from an information source as a data subset.

25. A method according to claim 1, further comprising:
selecting at least one information source for a plurality of services or applications.

26. A method according to claim 25, wherein the plurality of services include one or more of WAP services, multimedia services, or streaming video services.

27. A method according to claim 1, further comprising:
selecting at least one information source for at least one service for a plurality of virtual operators.

28. A method according to claim 1, wherein the collected data is performance data.

29. A terminal, comprising:
a user interface configured to receive receiving user inputs; and
a communications interface configured to connect to a communications network, wherein the user interface is configured to receive user parameters, and the communications interface is configured to transmit the parameters to the communications network.

30. A terminal according to claim 29, wherein the user parameters are indicative of a user's experience of using the communications network.

31. A terminal according to claim 29, wherein the user parameters are entered by selecting a numeric option.

32. A terminal according to claim 31, wherein the numeric option is provided by selection of a corresponding numeric keypad on the terminal.

33. A terminal according to claim 29, wherein the communications interface is configured to transmit the parameters using a messaging service.

34. A terminal according to any one of claim 29, wherein the terminal is a mobile terminal.

35. A network element in a communications system, comprising:
a communications interface configured to receive data from a terminal connected in said communications system, said data being representative of a user experience, and configured to provide said data to a learning neural network.

36. A network element according to claim 35, wherein the neural network learns the parameters associated with an unacceptable system level performance.

37. A network element according to claim 35, wherein the neural network generates an alarm signal responsive to receipt of data associated with a poor system level performance.

38. A computer program embodied within a computer readable medium for a mobile terminal for connection in a communications network, the computer program controlling the mobile terminal to perform:
displaying on a graphical user interface a selection of user experience quality of services;
receiving a user input from the terminal user interface; and
storing the user input in a terminal memory.

39. A computer program according to claim 38, further comprising:
after receiving a user input from the terminal user interface, reading the performance related parameters from the registers of the mobile terminal; and
storing the parameters into the memory together with the user input.

40. A computer program according to claim 38, further comprising:
starting the computer program automatically during a connection to the mobile network.
